(19) United States
(12) Patent Application Publication
(10) Pub. No.: US 2019/0240887 A1
(43) Pub. Date: Aug. 8, 2019

(54) METHOD AND DEVICE FOR THE PRODUCTION OF A PLASTIC FOIL

(71) Applicant: SML Maschinengesellschaft m. b. H., Lenzing (AT)

(72) Inventors: THOMAS RAUSCHER, Berg im Attergau (AT); Robert PREUNER, Weyregg (AT); Doris EBERHARD, Gaal (AT)

(21) Appl. No.: 16/262,227

(22) Filed: Jan. 30, 2019

(30) Foreign Application Priority Data
Feb. 2, 2018 (EP) 18 155 016.1

(51) Int. Cl. B29C 48/88; B29C 48/92; B29C 48/08; B29C 48/21

(52) U.S. Cl. CPC B29C 48/914; B29C 48/92; B29C 2948/92923; B29C 48/21; B29C 2948/92704; B29C 48/08

(57) ABSTRACT

A method and device for producing of a plastic foil especially a multi-layer stretch film, at which plastic material is extruded from a flat extrusion die and subsequently guided around a cooling roll following in the conveying direction and cooled. The foil is guided between the flat extrusion die and the cooling roll around a temperature controlling roll along a given angle of contact. The temperature controlling roll has a center region and two edge regions. The foil is kept at least in sections at a distance from the temperature controlling roll in the center region by creating an air cushion in the center region between the surface of the temperature controlling roll and the foil by supplying heated air between the surface of the temperature controlling roll and the foil in the center region. The foil is brought into contact with the temperature controlling roll in the edge regions.

### CROSS-REFERENCE TO RELATED APPLICATIONS

The present application claims priority of EP 18 155 016.1, filed Feb. 2, 2018, the priority of this application is hereby claimed and this application is incorporated herein by reference.

### BACKGROUND OF THE INVENTION

The invention relates to a method for the production of a plastic foil, especially of a multi-layer stretch film, at which plastic material is extruded from a flat extrusion die and is subsequently guided around at least one cooling roll following in the conveying direction and is cooled thereby, wherein the foil is guided between the flat extrusion die and the cooling roll around a temperature controlling roll along a given angle of contact. Furthermore, the invention relates to a device for the production of a plastic foil.

At the production especially of mufti-layer stretch films by means of the generic casting process the stretch film can be produced in a range of thickness between 6 μm and 50 μm. Such foils are for example used for wrapping of goods for load securing on a palette.

The stretch film consists of at least three layers. The intermediate layer is responsible for the mechanical stability. An outer layer is responsible for the “cling effect” (adhesive effect) of the film; the other outer layer takes care for a low coefficient of friction.

At the production of foils according to the generic process the molten polymer leaves a flat sheet die as foil curtain and is cast onto a rotating cast roll (cooling roll), The lateral edge of the foil is fixed at the rotating cast roll by means of air which leaves a nozzle jetlike or by means of electrostatic charging electrodes for the edge strip.

Thereby the foil leaves the gap of the nozzle with a first thickness and is drawn to the lower product thickness. The ratio of the thicknesses is called draw-down. In principle this is a stretching from the (thick) discharge gap of the nozzle to the (low) thickness of the finished foil on the chill roll.

By a quick cooling of the foil on the chill roll the state of stress of the foil, which results from the high and quick stretching from the nozzle, is frozen (memory effect of the polymer). Thereby, the foil has a high shrinkage and the mechanical parameters, especially the available elongation in longitudinal direction (ultimate) and puncture resistance of the foil as well as several other quality parameters which are important for the stretching of the foil are partially significantly deteriorated when the relaxation of the foil is cut by increasing production speeds.

Thereby, production speeds at the production of stretch foils in the range of 400 to 750 m/min are already sought and realised respectively. If nothing else a further increase of the line speed is limited by the effect that at higher speeds the stretch from the nozzle (thus finally the stretch speed) is further increased and thereby the above-mentioned deterioration of the quality of the foil takes place because the foil passes the distance between the outlet of the nozzle to the line of freezing on the chill roll in a shorter time. Finally, the foil has two less time for relaxation.

A possibility to counteract to this deterioration is to cool down the foil more slowly.

Insofar it is known that at the foil production according to the generic method (chill roll process) an increase of the distance from the outlet of the nozzle to the surface of the chill roll is sought so that for example the elongation of the produced foil in longitudinal direction of the foil is improved. Typically, the distance from the outlet of the nozzle to the surface of the chill roll is 15 to 40 mm. A doubling of the (usual maximal) gap to 80 mm leads already to a significant increase of the maximal expansibility of the foil. However, it is detrimental that the foil at the production is guided relatively instable in the relatively long gap and tends to rupture for which reason the mentioned approach has narrow confines.

From U.S. Pat. No. 4,608,221 A and U.S. Pat. No. 4,486,377 A devices are known which are arranged between nozzle and a cooling roll gap and which serve to avoid resonance vibrations of the foil in longitudinal direction of the foil. Those critical resonance vibrations of the foil in longitudinal direction of the foil are called draw resonance. Those documents are not dealing with the problem of a sufficient relaxation of the foil between nozzle and chill roll for the purpose of improvement of the properties of the foil.

Also, EP 3 228 436 A1 is dealing with the problem to prevent resonance vibrations in longitudinal direction of the foil of the material section of a laminar plastic material which is arranged between the outlet of a nozzle and a roll system. Here, for preventing of such resonance vibration an intermediate roll is arranged between nozzle and roll. Further processes for the production of foil-like plastic article are disclosed in U.S. Pat. No. 4,105,386 A and in EP 2 431 153 B1.

A process for the production of a laminate is disclosed in EP 1 095 767 B1 where a laminar plastic substrates which is leaving a nozzle is connected with a laminar metallic material.

### SUMMARY OF THE INVENTION

It is the object of the invention to create a method of the above mentioned kind as well as a respective device by which it is possible to produce a plastic foil from molten polymer by means of the cast foil process, wherein the foil should experience an improved relaxation to improve its properties and/or to increase the production speed insofar. By doing so especially the properties of a stretch foil should be improved.

The solution of this object by the invention is characterized in that the temperature controlling roll has a center region and two edge regions adjoining to the same, wherein the foil is kept at least in sections at a distance from the temperature controlling roll in the center region by creating a air cushion in the center region of the temperature controlling roll between the surface of the temperature controlling roll and the foil by supplying heated air between the surface of the temperature controlling roll and the foil in the center region of the temperature controlling roll, wherein the foil is brought into contact with the temperature controlling roll in the edge regions.

Preferably, in a region which extends along the width of the foil and from the side of the foil which is averted from the temperature controlling roll up to the cooling roll a vacuum against the ambient pressure is created. Thereby it is especially provided that the vacuum is created in the region from the lift off of the foil from the temperature controlling roll up to the contact of the foil with the cooling roll along the width of the foil. Preferably, thereby a distance (in radial direction of the rolls) between the temperature controlling roll and the cooling roll is chosen between 1 mm to 60 mm, specifically preferred between 15 mm and 25 mm (i. e. a gap of the mentioned magnitude), wherein said vacuum is created in this region. By doing so the foil is detached from the surface of the temperature controlling roll while the foil is simultaneously adapted to the cooling roll so that air entry is prevented between foil and cooling roll. So a good contact is given between foil and cooling roll and thus a good and equal cooling of the foil because locally introduced air cushions can be prevented reliably.

Preferably, the temperature of the pressurized air at its supply into the temperature controlling roll is between 60° C. and 350° C., preferably between 100° C. and 250° C.

The contact between the foil and the temperature controlling roll can thereby be created by electrostatic forces; an alternative to this provides that the contact between the foil and the temperature controlling roll is created by applying of an airstream onto the foil, Thereby, the contact between the foil and the temperature controlling roll is preferably limited to the edges of the foil.

The creation of the air cushion takes place preferably by supplying the heated pressurized air through a porous material of the temperature controlling roll in the center region of the temperature controlling roll between the surface of the temperature controlling roll and the foil. Hereby it is preferably provided that the temperature of the heated air is above of the Vicat softening temperature of the material of the foil, especially of an undercoating (clinglayer) of the foil.

The Vicat softening temperature according to DIN EN ISO 306 is measured by means of a needle (with circular area of 1 mm2). The same is charged with a test load of 10 N (test lead A) or 50 N (test load B). The test body with an allowed thickness of 3 to 6.4 mm is exposed to a definite heating rate of 50 respectively 120 K/h. The Vicat temperature is reached when the penetrating body reaches a penetration depth of 1 mm. This temperature sheds light on the practical long-term work limit of the material which lies about 15 K below the Vicat temperature.

The temperature controlling roll is kept according to a preferred embodiment of the proposed method on a higher temperature in the center region than in the edge regions, wherein the temperature in the edge regions is preferably kept between 10° C. and 95° C.

The angle of contact of the foil around the temperature controlling roll lies preferred between 50° and 180°.

The foil is thereby preferred conveyed with speed of at least 400 m/min, preferably of at least 750 m/min and specifically preferred with at least 900 m/min from the cooling roll.

The foil is thereby free from further laminated layers and as applied onto the temperature controlling roll conveyed from the cooling roll. Accordingly, no connection takes place of the foil with another substrate behind the outlet of the nozzle of the flat extrusion die. Insofar the proposed method is different from different other methods at which lamination processes are carried out at which the material which is extruded from the fiat extrusion die is connected with further substrates.

So, the foil is kept in the region of the temperature controlling roll at least along a part of its width at a predetermined temperature which lies above the temperature of the cooling roll, wherein the temperature of the cooling roll is kept preferably between 10° C. and 60° C. The temperature of the foil in the region of the temperature controlling roll lies preferably at least along a section of its axial extension between 60° C. and 350° C., especially between 100° C. and 250° C.

The device for the production of a plastic foil, especially of a multi-layer stretch film, comprises a flat extrusion die by which plastic material can be output and at least one cooling roll following subsequently in the conveying direction for cooling the foil, wherein a temperature controlling roll is arranged between the flat extrusion die and the cooling roll and around which the foil can be guided along a given angle of contact is characterized according to the invention in that the temperature controlling roll has a center region and two edge regions adjoining to the same, wherein the regions are formed by separate roll parts which follow in axial direction to another, wherein the temperature controlling roll consists in the center region at least in sections and at least partially from a porous material which is connected with at least one conduit for the supply of air into the porous material to create an air cushion between the foil and the center region and wherein means are arranged in the edge regions for creation of a contact between the foil and the temperature controlling roll.

Preferably, furthermore means for creation of a vacuum are provided in a region which extends along the width of the foil and from the side of the foil which is averted from the temperature controlling roll up to the cooling roll.

In the edge regions means can be arranged for creation of an electrostatic field and/or means for applying of an airstream onto the foil (wherein by the airstream the foil can be blown to the temperature controlling roll so that is adheres at the temperature controlling roll).

The temperature controlling roll consists according to a preferred embodiment of the invention in the center region and also in both edge regions of rotationally symmetric parts which each are connected with an electromotive drive to drive at the one hand the rotationally symmetric part of the center region and at the other hand the rotationally symmetric parts of both edge regions with individual rotational speed.

An alternative embodiment provides that the temperature controlling roll consist of rotationally symmetric parts in both edge regions which each are connected with an electromotive drive, wherein the part of the temperature controlling roll which forms the center region is arranged in a non-rotatable manner. At this embodiment it can be further provided that the center region is formed by a non rotationally symmetric part (by doing so the porous designed and relatively expensive section of the center region can be kept small).

It can further be provided that in a section above the gap between the temperature controlling roll and the cooling roll, thus especially above the region in which a vacuum is created, an infrared heater for heating of the foil is arranged in the region of the enlacement of the foil around the temperature controlling roll. This infrared heater extends preferably along the whole width of the center region of the temperature controlling roll.

By the creation of the mentioned air cushion, which keeps the foil quasi hovered above the surface of the center region of the temperature controlling roll, the necessity is not given that the center region of the temperature controlling roll is rotating during the operation of the device. Rather this section of the temperature controlling roll can be stationary; in this case only the two section of the temperature controlling roll are rotating which form the two edge region of the same. The circumferential speed of the edge regions of the temperature controlling roll is preferably 0.5 to 1.0 of the circumferential speed of the cooling roll.

Then, in both edge regions of the temperature controlling roll a tempering (for example by means of water or oil) can take place.

The diameter of the temperature controlling roll lies preferably in a region between 120 mm and 400 mm.

If the center region of the temperature controlling roll is arranged stationary, i. e. if it does not rotate, it can be provided as a preferred embodiment that this part which is not enlaced by the foil is designed not rotationally symmetric; it can rather be designed arbitrary, This has the benefit that the micro-porous area for conveyance of air for the creation of the air cushion can be kept small which has economical advantages.

If it is however provided that also the center region of the temperature controlling roll rotates, then for this region a circumferential speed can be provided which is 0.5 to 2.0 of the circumferential speed of the cooling roll. Thus, if also the center region of the temperature controlling roll is driven it is preferably provided to rotate the same with a higher rotational speed than the edge regions.

A stationary center region of the temperature controlling provided porous surface for conveyance of air for the creation of the air cushion has different advantages: The introduction of air for the creation of the air cushion into the inner of the temperature controlling roll is quite easy with respect to the design of the device because the introduction of air can take place at any location without rotary feedthrough, especially at the side of the temperature controlling roll which is averted from the region which is enlaced by the foil. So, the device can be realized cost-efficiently. Furthermore, a relative speed exists between the moving foil and the air cushion which leads to an improved more equal heat transfer between foil and air (then another relevant Nusselt number is given which determines the convective heat transfer). Finally, the foil slides due to the relative movement to the air cushion specifically easy. So, pressurized air can be saved and disturbances of the foil surface can reliably be prevented.

As explained above, the foil is thus preferably kept on a lower temperature level in both edge regions than in the center region. By the lower foil temperature in the edge regions quasi carriage straps are created which are relatively stable and which move respectively guide the foil in the less stable center region. However, in the center region of the foil, which is after the lateral cut the usable part of the foil, a higher temperature is kept which beneficially ensures an optimized relaxation of the foil.

To ensure that the warmer center region of the foil does not stays behind the colder and thus more ductile edge regions of the foil the possibility is given to increase the rotational speed of the center part of the temperature controlling roll against the edge regions of the temperature controlling roll. Due to the increased although small existing friction between air cushion and foil the center region of the foil is noticeable accelerated and levels a possible given distortion of the foil by a chosen increased surface speed of the center region. Of course this requires a higher investment in the device due to separate drives of the center region and the edge parts of the temperature controlling roll. Furthermore, the necessity is given in this case to introduce coaxially two media, namely water for tempering of the edge regions and heated pressurized air for the supply of the porous center part. However, with respect to the process technology this is the concept with the most degrees of freedom.

The provided temperature controlling roll functions as relaxation device especially at the production of flat foils in which the plastic material can especially be optimized for the use in a stretch film. Namely the path of the foil from the nozzle to the cooling roll is elongated by the interposed temperature controlling roll (relaxation device).

The foil consisting of thermoplastic polymers is thus not directly extruded onto the cooling roll but onto a relaxation device which is arranged between nozzle outlet and cooling roll and only then in a subsequent step transferred to the following cooling roll at which it is cooled down below the solidification temperature and to ambient temperature respectively.

Preferably, a “vacuum box” is arranged between the temperature controlling roll and the cooling roll which minimizes an air entry between the cooling roll and the foil.

The temperature controlling roll (relaxation device) is preferably divided into the three above mentioned sections (center region and edge regions) and is driven. In the edge regions an adherence of the foil at the temperature controlling roll takes place for which air jet nozzles or electrodes are employed which work according to the principle of electrostatic charging.

The temperature controlling roll itself is provided with a tempering, wherein a supplied heat carrier medium (e. g. water or oil) can be lead through the roll to regulate the surface of the roll to a certain temperature. The width of the center region corresponds to the width of the usable cut foil. Here, preferably a porous (ceramic or metallic) material is used as surface material for the temperature controlling roll so that by introducing of air an air cushion can be created which keeps away the foil from the surface of the temperature controlling roll in the center region and thus prevents an adherence. The foil can thus slide on the temperature controlling roll without problems.

The introduced air for the creation of the air cushion is thereby heated so that it becomes possible to keep the foil at a relatively high temperature which is especially higher than the temperature of the surface of the following cooling roll. Thereby it is possible to postpone a complete solidification of the foil to obtain thereby a relaxation of the foil at a higher temperature level.

For the temperature of the air cushion preferably a range between 60° C. and 350° C. is provided, specifically preferred between 100° C. and 250° C. In the case of the manufacturing of stretch films especially a temperature can therefore be used above the Vicat softening temperature of the polymer of the laminate which is used for the cling outer layer.

With the present invention a method is provided by which a flat film can be produced in the generic manner (thus by the chill roll process) which can be relaxed in an improved manner. Thereby better mechanical foil properties can be obtained. Thereby at first the puncture resistance has to be mentioned which can be improved accordingly. Furthermore, the remaining shrinkage of the foil can be relaxed and reduced respectively, Especially the remaining elongation in longitudinal direction in the foil is increase at otherwise similar parameters and conditions respectively. Especially in connection with “stretch wrap” foils the “ultimate” of the foil is improved which is an important parameter for the properties of the foil at the wrapping process (“stretch process”) of palettes.

However, the improved relaxation in the foil at the use of the proposed device can reversely be used beneficially also for an increase of the speed of the production device. By the increase of the speed at first the load is increased due to the increased stretch speed from the flat extrusion die what is detrimental and partially consumes the effect from the gained relaxation. However, the gain is a higher output of the facility by maintaining the quality level of the foils. So, the economy of the facility can be significantly improved.

Thus, by the proposed method a better relaxed foil with improved mechanical properties is provided. The improvement of the ultimate is obtained therefore by a longer melt curtain which is guided around the temperature controlling roll between the outlet of the flat extrusion die and the cooling roll in the air gap between the die and the cooling roll, Thereby the stretch speed from the die is reduced and also the relaxation time is increased,

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows in the side view a device for the production of a multi-layer plastic foil and

FIG. 2 shows in the front view a part of the device according to FIG. 1 in which additionally the attaching of the foil which has to be produced at a temperature controlling roll is shown.

### DETAILED DESCRIPTION OF THE INVENTION

In the figures a device is shown by which a multi-layer stretch film 1 can be produced. For doing so plastic melt which is already prepared as a multi-layer laminate is extruded via an outlet of a flat extrusion die 2 so that a foil with a certain width is provided. From the outlet of the flat extrusion die 2 the foil is applied onto a temperature controlling roll 4 which functions as a relaxation device. The foil 1 enlaces thereby the temperature controlling roll 4 around an angle of contact α. From the temperature controlling roll 4 the foil 1 reaches a cooling roll 3 from which the cooled foil is taken off by an lifting roll 10 from the cooling roll 3 and is further conveyed (in conveying direction F).

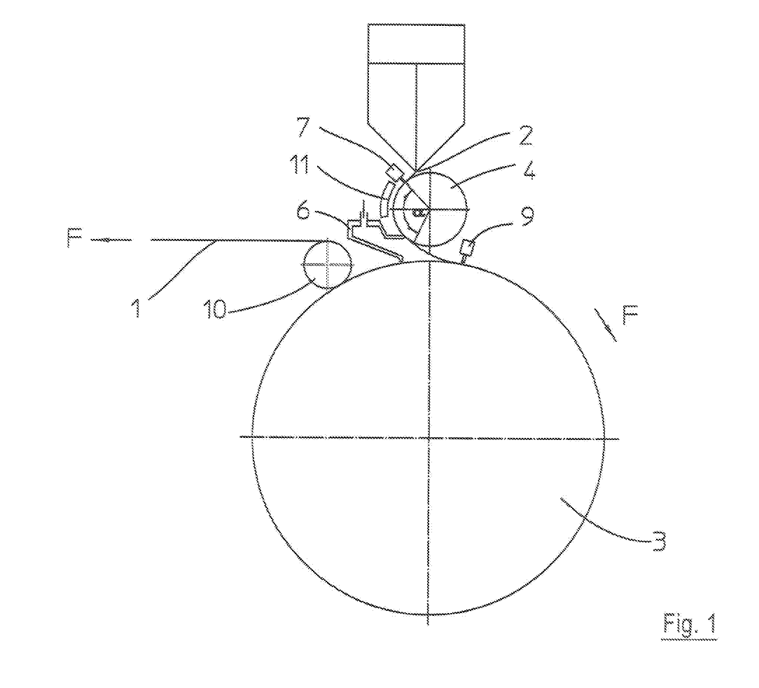

To make sure that between foil 1 and cooling roll 3 at the explained guidance of the foil no air gets around the cooling roll 3 means 6 are provided for the creation of a vacuum (vacuum box) which apply at the outer surface of the foil 1 in the region of the temperature controlling roll 4 and end at the outer circumference of the cooling roll 3. From this region air is evacuated what is indicated in FIG. 1 by the arrow at the means 6.

To make sure that the foil 1 at its cooling by means of the cooling roll 3 contacts the same well it is pressed and drawn respectively to the cooling roll in its both edge regions by means 9 for creation of a contact between the foil 1 and the cooling roll 3. This can take by means of an airstream or by means of electrostatic charging.

Between the discharge of the foil 1 from the flat extrusion die 2 and the means 6 for the creation of a vacuum an infrared heater 11 is arranged to make sure additionally that the foil 1 can be kept at a desired temperature.

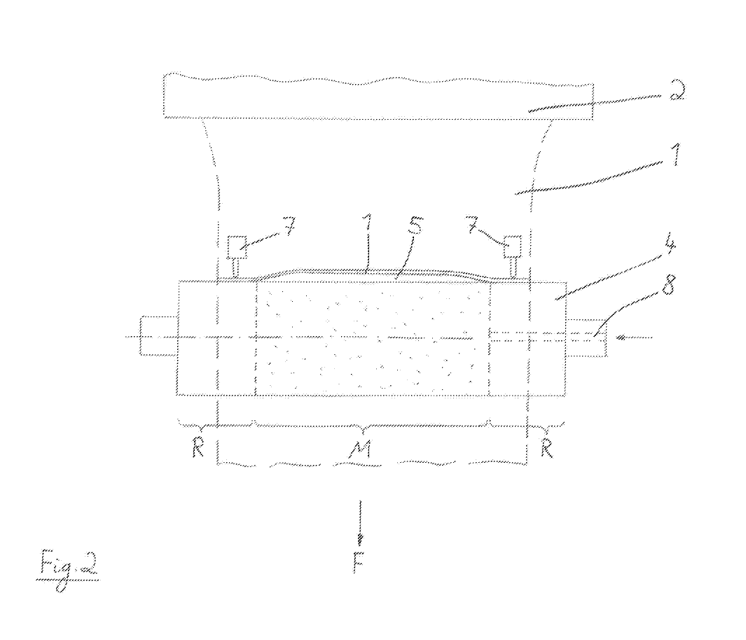

In FIG. 2 details of the embodiment of the temperature controlling roll 4 are depicted whereby the same comprises a center region M as well as two lateral edge regions R. The center region M is formed by a surface made of porous material which is in connection with a conduit 8 for the introduction of air (see arrow in FIG. 2 in the region of the reference numeral 8). However in the two edge regions R of the temperature controlling roll 4 means 7 are provided for the creation of a contact between the foil 1 and the temperature controlling roll 4 which are realized preferably by an airstream or by means for the creation of an electrostatic charging. Accordingly air is supplied via the conduit 8 and discharged via the porous material in the center region M of the temperature controlling roll 4 so that an air cushion 5 is created between the surface of the temperature controlling roll 4 in its center region and the foil 1 which keeps the foil 1 away from the temperature controlling roll 4. This is schematically shown in FIG. 2, wherein this is shown in the figure pivoted from the actual contact plane between foil 1 and temperature controlling roll 4.

The air which is supplied via the conduit 8 to the temperature controlling roll is thereby heated by suitable means (e. g. by means of an industrial blow dryer) in such a manner that the air cushion 5 has a respective high temperature to maintain the above-mentioned process conditions.

of the flat extrusion die 2 and is casted with short distance onto the below arranged relaxation device in the form of the temperature controlling roll 4. The foil curtain is fixed in the edge region R on the rotating roll body of the temperature controlling roll 4 by means of edge strip electrodes which are working according to the principle of the electrostatic charging. The center region M of the temperature controlling roll 4 has a micro-porous surface from which air is leaving which is introduced via the conduit 8; thereby the air cushion 5 is formed on which the casted foil 1 can slide without damage. The casted foil 1 enlaces the temperature controlling roll 4 along an angle of contact a which is about 120° in the embodiment and is then with short distance transferred to the below arranged cooling roll 3. The foil 1 is fixed again at the cooling roll 3 with edge fixation means 9 (electrostatic charging electrodes or airstream).

To prevent an air entry between foil 1 and surface of the cooling roll 3 the exit of the vacuum box 6 is arranged in the gap between the temperature controlling roll 4 and the cooling roll 3 and so a vacuum is created in that region.

To utilize the cooling length of the cooling roll 3 as far as possible the cooling roll 3 is enlaced by the foil as far as possible, namely in the embodiment till the lifting roll 10 which is arranged immediately adjacent to the mentioned vacuum box 5.

The air which leaves the porous ceramic of the center region M of the temperature controlling roll 4 forms, as explained, the air cushion 5 on which the foil 1 can slide. Thereby the air which is introduced for the creation of the air cushion 5 is heated, namely up to the above mentioned values. Thereby the temperature of the air which is introduced via the conduit 8 for creating the air cushion 5 can also be selected higher than the melt temperature of the adjacent polymer. Due to the so increased temperature of the air which forms the air cushion 5 the foil 1 over the air cushion 5 is cooled only very slowly or not cooled at all.

As the case may be, the average foil temperature can thereby be kept above the Vicat temperature so that it does not completely solidify but allows a continued relaxation of the foil structure with high relaxation speed.

Without the proposed measures the danger would be given that the foil 1 sticks together with the surface of the temperature controlling roll 4 in its center region M. This is prevented by the air which is introduced via the conduit 8 and thus by the so created air cushion 5. The air cushion 5 prevents as well that the porous surface of the center region M of the temperature controlling roll 4 is polluted.

The edge regions R of the temperature controlling roll 4 correspond with their diameter to the curvature of the center region M which is enlaced by the foil. The edge regions R can also be tempered, wherein here a temperature range between 10° C. and 95° C. is provided. The temperature is here chosen in such a manner that the foil 1 cools down so far that stable foil strips are created in the region of the foil edges between which the center region of the foil 1 which hovers on the air cushion 5 is quasi clamped and is so drawn forward by the edges. The edge regions of the foil which are insofar stabilized thus stable the transport of the center region of the foil 1.

The temperature controlling roll 4 is driven by an electric motor. The circumferential speed of the temperature controlling roll is thereby preferably 0.5 to 1.0 times of the circumferential speed of the cooling roll 3. The speed is thereby adjusted in just a manner that at the one hand the “neck-in” of the foil 1 is reduced and but at the other hand the section which hovers over the air cushion 5 does not advance or stays back.

For the discharge of the hot air from the center region of the temperature controlling roll an air shield can be provided.

The selection of the temperature of the air cushion depends on the present layers of the foil. If for example PET is present as layer in the foil the melting point of this layer is significantly higher. In this case the air temperature can even be increased above the melting temperature of the cling material of the foil. Despite of this no danger is given that the foil ruptures.

A high temperature in the center region of the temperature controlling roll is very beneficial with respect to the relaxation and also with regard to the surface quality of the foil when the same contacts the cooling roll.

Due to the three-part design of the temperature controlling roll (three parts which follow in axial direction subsequently) it becomes possible in a simple manner to carry out a fixation of the edge strip and so to prevent the neck-in of the foil. Apart from this it is reached by the created air cushion that the foil in the center region of the temperature controlling roll slides and “hovers” respectively on the surface of the roll.

It can be provided by the proposed method that sufficient time as well as an optimal temperature is given for the relaxation, wherein it is also taken care that an optimized guidance of the foil is given and the same is also guided in a stable manner at high production speeds.

In this connection it is beneficial if at the one hand the edge regions of the temperature controlling roll and at the other hand the center region of the same are driven independently from another, i. e. with the possibility of different rotational speeds. With the separate drive the possibility is given to rotate the center region faster than the edge parts of the roll and so to create a drag effect.

By the heated air for creating the air cushion which compensates the cooling of the foil the beneficial possibility is given to keep the relaxation way large by choosing the diameter of the temperature controlling roll correspondingly. However always a stable foil guidance is given.

While specific embodiments of the invention have been shown and described in detail to illustrate the inventive principles, it will be understood that the invention may be embodied otherwise without departing from such principles.

### LIST OF REFERENCES

1 Plastic foil (multi-layer stretch film)
2 Flat extrusion die with nozzle outlet
3 Cooling roll
4 Temperature controlling roll (relaxation device)
5 Air cushion
6 Means for creation of a vacuum (vacuum box)
7 Means for creation of a contact between the foil and the temperature controlling roll
8 Conduit for the supply of air
9 Means for creation of a contact between the foil and the cooling roll
10 Lifting roll
11 Infrared heater
M Center region of the temperature controlling roll (made of porous material)
R Edge region of the temperature controlling roll (driven rotating roll body)
F Conveying direction
α Angle of contact

We claim:

1. A method for the production of a plastic foil, especially of a multi-layer stretch film, at which plastic material is extruded from a flat extrusion die and is subsequently guided around at least one cooling roll following in the conveying direction and is cooled thereby, wherein the foil is guided between the flat extrusion die and the cooling roll around a temperature controlling roll along a given angle of contact, wherein the temperature controlling roll has a center region and two edge regions adjoining to the same, wherein the foil is kept at least in sections at a distance from the temperature controlling roll in the center region by creating an air cushion in the center region of the temperature controlling roll between the surface of the temperature controlling roll and the foil by supplying heated air between the surface of the temperature controlling roll and the foil in the center region of the temperature controlling roll, wherein the foil is brought into contact with the temperature controlling roll in the edge regions.

2. The method according to claim 1, wherein in a region which extends along the width of the foil and from the side of the foil which is averted from the temperature controlling roll up to the cooling roll a vacuum against the ambient pressure is created, wherein the vacuum is created especially in the region from the lift off of the foil from the temperature controlling roll up to the contact of the foil with the cooling roll along the width of the foil.

3. The method according to claim 1, wherein the temperature of the pressurized air at its supply into the temperature controlling roll is between 60° C. and 350° C., preferably between 100° C. and 250° C.

4. The method according to claim 3, wherein the contact between the foil and the temperature controlling roll is created by electrostatic forces and/or that the contact between the foil and the temperature controlling roll is created by applying of an airstream onto the foil, wherein the contact between the foil and the temperature controlling roll is preferably limited to the edges of the foil.

6. The method according to claim 1, wherein the creation of the air cushion takes place by supplying the heated pressurized air through a porous material of the temperature controlling roll in the center region of the temperature controlling roll between the surface of the temperature controlling roll and the foil.

6. The method according to claim 1, wherein the temperature of the heated air is above of the Vicat softening temperature of the material of the foil, especially of an undercoating of the foil (1).

7. The method according to claim 1, wherein the temperature controlling roll is kept on a higher temperature in the center region than in the edge regions, wherein the temperature in the edge regions is preferably kept between 10° C. and 95° C.

8. The method according to claim 1, wherein the foil is conveyed with speed of at least 400 m/min, preferably of at least 750 m/min and specifically preferred with at least 900 m/min from the cooling roll.

9. The method according to claim 1, wherein the foil is free from further laminated layers and as applied onto the temperature controlling roll is conveyed from the cooling roll.

10. A device for the production of a plastic foil, especially of a multi-layer stretch film, comprising a flat extrusion die by which plastic material can be output and at least one cooling roll following subsequently in the conveying direction for cooling the foil, wherein a temperature controlling roll is arranged between the flat extrusion die and the cooling roll and around which the foil can be guided along a given angle of contact, wherein the temperature controlling roll has a center region and two edge regions adjoining to the same, wherein the regions are formed by separate roll parts which follow in axial direction to another, wherein the temperature controlling roll consists in the center region at least in sections and at least partially from a porous material which is connected with at least one conduit for the supply of air into the porous material to create an air cushion between the foil and the center region and wherein means are arranged in the edge regions for creation of a contact between the foil and the temperature controlling roll.

11. A device according to claim 10, wherein means for creation of a vacuum are provided in a region which extends along the width of the foil and from the side of the foil which is averted from the temperature controlling roll up to the cooling roll.

12. A device according to claim 10, wherein in the edge regions means are arranged for creation of an electrostatic field and/or means for applying of an airstream onto the foil.

13. A device according to claim 10, wherein the temperature controlling roll consists in the center region and also in both edge regions of rotationally symmetric parts which each are connected with an electromotive drive to drive at the one hand the rotationally symmetric part of the center region and at the other hand the rotationally symmetric parts of both edge regions with individual rotational speed.

14. A device according to claim 10, wherein the temperature controlling roll consist of rotationally symmetric parts in both edge regions which each are connected with an electromotive drive, wherein the part of the temperature controlling roll which forms the center region is arranged in a non-rotatable manner.

15. A device according to claim 14, wherein the center region is formed by a non rotationally symmetric part.
